(19) United States
(12) Patent Application Publication
(10) Pub. No.: US 2026/0010141 A1
(43) Pub. Date: Jan. 8, 2026

(54) SYSTEM AND METHOD FOR CONTROLLING MACHINE ACCESS

(71) Applicant: Oshkosh Corporation, Oshkosh, WI (US)

(72) Inventors: Korry D. Kobel, Oshkosh, WI (US); Fredric L. Yutzy, Oshkosh, WI (US); Dan Adamson, Oshkosh, WI (US); Patrick Booth, Oshkosh, WI (US)

(73) Assignee: Oshkosh Corporation, Oshkosh, WI (US)

(21) Appl. No.: 19/323,885

(22) Filed: Sep. 9, 2025

Related U.S. Application Data
(63) Continuation of application No. PCT/US2024/019218, filed on Mar. 8, 2024.
(60) Provisional application No. 63/489,562, filed on Mar. 10, 2023.
(60) Provisional application No. 63/451,342, filed on Mar. 10, 2023.
(60) Provisional application No. 63/489,560, filed on Mar. 10, 2023.
(60) Provisional application No. 63/451,387, filed on Mar. 10, 2023.
(60) Provisional application No. 63/489,533, filed on Mar. 10, 2023.
(60) Provisional application No. 63/451,390, filed on Mar. 10, 2023.
(60) Provisional application No. 63/489,558, filed on Mar. 10, 2023.
(60) Provisional application No. 63/451,506, filed on Mar. 10, 2023.
(60) Provisional application No. 63/489,538, filed on Mar. 10, 2023.
(60) Provisional application No. 63/489,531, filed on Mar. 10, 2023.
(60) Provisional application No. 63/451,504, filed on Mar. 10, 2023.
(60) Provisional application No. 63/451,351, filed on Mar. 10, 2023.

(51) Int. Cl. G05B 19/409; G06F 3/0484

(52) U.S. Cl. CPC G05B 19/409; G05B 2219/32128; G06F 3/0484

(57) ABSTRACT

A system may include a connectivity module, the connectivity module communicatively and physically coupled to the work machine. The system may include one or more processing circuits configured to affect at least one functionality of the work machine, the one or more processing circuits comprising one or more memory devices coupled to one or more processors, the one or more memory devices configured to store instructions thereon that, when executed by the one or more processors, cause the one or more processors to: designate at least one selected work machine, receive data indicative of one or more access control settings of the selected work machine, send a signal configured to cause a modification to the one or more access control settings of the selected work machine; and cause the modification to the one or more access control settings of the selected work machine.

### CROSS-REFERENCE TO RELATED APPLICATIONS

This application is a continuation of International Patent Application No. PCT/US2024/019218, filed on Mar. 8, 2024, which claims the benefit of and priority to (i) U.S. Provisional Application No. 63/451,342, filed on Mar. 10, 2023, (ii) U.S. Provisional Application No. 63/451,351, filed on Mar. 10, 2023, (iii) U.S. Provisional Application No. 63/451,387, filed on Mar. 10, 2023, (iv) U.S. Provisional Application No. 63/451,390, filed on Mar. 10, 2023, (v) U.S. Provisional Application No. 63/489,533, filed on Mar. 10, 2023, (vi) U.S. Provisional Application No. 63/451,504, filed on Mar. 10, 2023, (vii) U.S. Provisional Application No. 63/489,562, filed on Mar. 10, 2023, (viii) U.S. Provisional Application No. 63/451,506, filed on Mar. 10, 2023, (ix) U.S. Provisional Application No. 63/489,531, filed on Mar. 10, 2023, (x) U.S. Provisional Application No. 63/489,538, filed on Mar. 10, 2023, (xi) U.S. Provisional Application No. 63/489,558, filed on Mar. 10, 2023, and (xii) U.S. Provisional Application No. 63/489,560, filed on Mar. 10, 2023, each of which is hereby incorporated by reference herein in its entirety.

### BACKGROUND

Work equipment such as lifts and telehandlers sometimes require identifying, tracking, tasking, monitoring, and servicing at a work site. Managers and operators of working machines typically rely on discrete systems, applications, and methods to perform these functions for each piece of equipment.

### SUMMARY OF THE DISCLOSURE

In some aspects, the techniques described herein relate to a system for controlling access to a work machine, the system including a connectivity module, the connectivity module communicatively and physically coupled to the work machine; one or more processing circuits configured to affect at least one functionality of the work machine, the one or more processing circuits including one or more memory devices coupled to one or more processors, the one or more memory devices configured to store instructions thereon that, when executed by the one or more processors, cause the one or more processors to: designate at least one selected work machine; receive data indicative of one or more access control settings of the selected work machine; send a signal configured to cause a modification to the one or more access control settings of the selected work machine; and cause the modification to the one or more access control settings of the selected work machine.

In some aspects, the techniques described herein relate to a system, further including a user device including a GUI and including at least one of a laptop, a cellular device, a tablet, a computer, or a remote computer system, the user device configured to: receive, via the GUI, a designation of the at least one selected work machine; and send the designation of the at least one selected work machine to the connectivity module or the one or more processing circuits via a network connection.

In some aspects, the techniques described herein relate to a system, wherein the data indicative of the one or more access control settings of the selected work machine includes at least one of a status of the selected work machine, a state of the selected work machine, a functionality of the selected work machine, a membership of the selected work machine in a group, an identity of a user who may check in or check out the selected work machine, a credential requirement to access the selected work machine, a time period of permitted use, or a geographic location of permitted use.

In some aspects, the techniques described herein relate to a system, wherein the modification to the one or more access control settings is setting a state of the selected work machine to a tow mode or a low-speed mode upon a next start-up of the selected work machine.

In some aspects, the techniques described herein relate to a system for controlling access to one or more work machines, wherein the connectivity module is configured to indicate a status or condition of the at least one selected work machine.

In some aspects, the techniques described herein relate to a system, wherein: the modification to the one or more access control settings of the selected work machine disables at least one functionality or system of the selected work machine; and wherein the one or more memory devices are configured to store instructions thereon that, when executed by the one or more processors, further cause the one or more processors to: receive a signal configured to re-enable the disabled at least one functionality or system of the selected work machine upon satisfaction of a condition.

In some aspects, the techniques described herein relate to a system, wherein the one or more memory devices are configured to store instructions thereon that, when executed by the one or more processors, further cause the one or more processors to: indicate the modification to the one or more access control settings by causing at least one of an audible signal or a visual signal; the at least one selected work machine is one of a plurality of work machines; the connectivity module is one of a plurality of connectivity modules, each connectivity module of the plurality of connectivity modules including: a self-contained unit physically coupled to one work machine of the plurality of work machines, and includes a beacon, the beacon including one or both of a light or sound generator, wherein the beacon is configured to identify the one work machine to which it is physically coupled by generating one or both of the audible signal or the visual signal.

In some aspects, the techniques described herein relate to a system for controlling access to a work machine, the system including: one or more processing circuits including one or more memory devices coupled to one or more processors, the one or more memory devices configured to store instructions thereon that, when executed by the one or more processors, cause the one or more processors to: generate a GUI including a list including the work machine; receive, via a network, a signal indicative of a selected work machine and a connectivity module coupled thereto; receive at least one access control setting associated with the selected work machine; receive, via the GUI, an indication to set or change the at least one access control setting associated with the selected work machine; send a signal to the connectivity module, the signal configured to set or change the at least one access control setting of the selected work machine; and cause the at least one access control setting of the selected work machine to be set or changed.

In some aspects, the techniques described herein relate to a system, further including a user device communicatively connected to the network, the user device including a screen and including at least one of a laptop, a cellular device, a tablet, a computer, or a remote computer system; wherein the one or more memory devices are configured to store instructions thereon that, when executed by the one or more processors, further cause the one or more processors to cause the GUI to display on the screen of the user device, and receive, from the user device and in response to an indication of a selection of one or more machines from the list, the signal indicative of the selected work machine and the connectivity module coupled thereto.

In some aspects, the techniques described herein relate to a system, wherein the at least one access control setting associated with the selected work machine includes at least one of a status of the selected work machine, a state of the selected work machine, a functionality of the selected work machine, a membership of the selected work machine in a group, an identity of a user who may check in or check out the selected work machine, a credential requirement to access the selected work machine, a time period of permitted use, or a geographic location of permitted use.

In some aspects, the techniques described herein relate to a system, wherein the indication to set or change the at least one access control setting associated with the selected work machine is received automatically upon the work machine meeting a criteria or preset setting.

In some aspects, the techniques described herein relate to a system, wherein the indication to set or change the at least one access control setting associated with the selected work machine includes a command to limit or disable at least one functionality of the selected work machine; and the connectivity module coupled thereto is configured to indicate that the at least one functionality is limited or disabled by activating a beacon.

In some aspects, the techniques described herein relate to a system, wherein the one or more memory devices are configured to store instructions thereon that, when executed by the one or more processors, further cause the one or more processors to cause an onboard display of the selected work machine to provide an indication of a change in status of the selected work machine.

In some aspects, the techniques described herein relate to a system for controlling access to one or more work machines, wherein the connectivity module is one of a plurality of connectivity modules, each connectivity module of the plurality of connectivity modules including a beacon, the beacon including one or both of a light or sound generator, wherein the beacon is configured to identify the work machine to which it is physically coupled by generating one or both of an audible signal or a visual signal.

In some aspects, the techniques described herein relate to a method for controlling access to a work machine, the method including generating, by one or more processing circuits, a GUI including a list including the work machine; receiving, by the one or more processing circuits, via a wireless network, a signal indicative of a selected work machine and a connectivity module coupled thereto; receiving, by the one or more processing circuits, at least one access control setting associated with the selected work machine; receiving, by the one or more processing circuits, via the GUI, an indication to set or change the at least one access control setting associated with the selected work machine; sending, by the one or more processing circuits, a signal to the connectivity module, the signal configured to set or change the at least one access control setting of the selected work machine; and causing, by the one or more processing circuits, the at least one access control setting of the selected work machine to be set or changed.

In some aspects, the techniques described herein relate to a method, further including causing, by the one or more processing circuits, the GUI to display on a screen of a user device; and receiving, by the one or more processing circuits, an indication of a selection of one or more machines from the list.

In some aspects, the techniques described herein relate to a method, wherein the at least one access control setting associated with the selected work machine includes at least one of a status of the selected work machine, a state of the selected work machine, a functionality of the selected work machine, a membership of the selected work machine in a group, an identity of a user who may check in or check out the selected work machine, a credential requirement to access the selected work machine, a time period of permitted use, or a geographic location of permitted use.

In some aspects, the techniques described herein relate to a method, further including indicating, by the one or more processing circuits, a modification to the at least one access control setting by causing at least one of an audible signal or a visual signal to occur on the selected work machine.

In some aspects, the techniques described herein relate to a method, further including receiving, by the one or more processing circuits, a signal configured to re-enable a disabled functionality or a disabled system of the selected work machine upon a satisfaction of a condition.

In some aspects, the techniques described herein relate to a method, further including causing, by the one or more processing circuits, an onboard display of the selected work machine to provide an indication of a change in status of the selected work machine.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a schematic representation of a work machine including a machine control module according to some embodiments.

FIG. 2 is a schematic representation of a local fleet connectivity system, according to some embodiments.

FIG. 3 is a schematic representation of a local fleet connectivity system with a central integration module, according to some embodiments.

FIG. 4 is a schematic representation of a work site and equipment staging area with a local fleet connectivity system deployed, according to some embodiments.

FIG. 5 is a picture representation of a work site with a local fleet connectivity system connecting two pieces of equipment, according to some embodiments.

FIG. 6 is a picture representation of a piece of equipment with a local fleet connectivity system and a system for controlling access to work machines providing connectivity to a remote user, according to some embodiments.

FIG. 7 is a schematic representation of a work site with a local fleet connectivity system deployed with connectivity to off-site systems, according to some embodiments.

FIG. 8 is a picture representation of an apparatus configured with a local fleet connectivity system, according to some embodiments.

FIG. 9 is a graphical user interface of the local fleet connectivity system of FIG. 2, according to some embodiments.

FIG. 10 is a picture representation of work machines configured for use in the local fleet connectivity system of FIG. 2 and a system for controlling access to work machines, according to some embodiments.

FIG. 11 is a picture representation of a work machine provisioned with an integrated connectivity module and beacon, according to some embodiments.

FIG. 12 is a drawing representing a view of user interface of a local fleet connectivity system, according to some embodiments.

FIG. 13 is drawing of another view of the user interface of a local fleet connectivity system of FIG. 12, according to some embodiments.

FIG. 14 is a flow diagram of a method for controlling access to work machines, according to some embodiments.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Work equipment such as lifts and telehandlers sometimes require tracking, tasking, monitoring, and servicing at a work site. Managers and operators of working machines typically rely on discrete systems, applications, and methods to perform these functions for each piece of equipment. It is therefore desirable to provide a means to automatically electronically connect and group work equipment on a work site and control/regulate the access to or functionality of such work equipment on a common platform to improve efficiency and reduce costs. Worksites may encompass a large area or many pieces of equipment. It may be desirable to provide a means for quickly and effectively locating and identifying a particular piece of equipment and controlling/regulating the functionality, credentials required for access, etc. of such equipment. It may also be desirable to provide a means for identifying a particular machine or a group of machines in order to modify, limit, or lock the status, state, or functionalities of one or more machines or the group of machines. For example, in a rental situation or other scenarios, it may be beneficial for an owner, remote user, or controller of a group of work machines to quickly identify a machine or group of machines and disable access or functionalities of the machine or group of machines (e.g., disable use of one or more machines when a rental period has expired, disable use of one or more machines during inclement weather, disable use of one or more machines when a worksite is closed, etc.).

Referring to the figures generally, various exemplary embodiments disclosed herein relate to systems and methods for controlling access to work machines, including wirelessly networked work machines capable of automatically generating work site equipment groupings. For example, work machines connected on a local area network may automatically associate a group of machines at a work site and exchange machine group information with nodes connected to the cloud for data processing and for fleet management. The system for controlling access to work machines may be interoperable with a local fleet connectivity system. The local fleet connectivity system may, for example, automatically generate a group of machines as a local fleet, a work site fleet, or other classification such that the automatically generated “work site” group facilitates the ability of the system for controlling access to work machines to control or regulate access of the machines in the group. In a further example, a group of all connected machines on a particular work site may be easily identified and grouped by site, such that the system of the present disclosure may regulate access to or the functionalities of one or more machines in the group. Additionally, the system for controlling access to work machines may regulate which users have access permissions to check certain machines in or out. In another example, the system for controlling access to work machines is configured to authenticate a network connection request from a device to prevent hacking. The system may also disable, lock, or limit the functionalities of a work machine in a work site equipment grouping when the machine goes into a selected and defined mode (e.g., once a machine enters tow mode the machine can no longer exit tow mode, lock or disable the functionalities of a work machine only after the machine is turned off, etc.). The system is also configured to support enterprise resource planning (ERP) integrations into rental contracts for time and location based data inputs from connected machines (e.g., disable functionalities once rental contract expires, enable functionalities when rental period is extended, disable certain functionalities based on terms of a rental contract, etc.).

Further referring to the figures generally, the various exemplary embodiments disclosed herein relate to systems, apparatuses, and methods for a system for controlling access to work machines that may be interoperable, for example, with a local fleet connectivity system that employs Bluetooth Low Energy (BLE) Machine to Machine (M2M) communication protocols to expand communication and improve productivity at a work site/jobsite. In some embodiments, the system for controlling access to work machines is interoperable with a local fleet connectivity system that comprises work machines, interface modules, work site equipment, communications devices, communications networks, user interface devices, devices hosting self-forming network software (e.g., local fleet connectivity system software), equipment users, equipment maintainers, and equipment suppliers. The information provided to the local fleet connectivity system can be communicated to the user of the system for controlling access to work machines via a user interface. In some embodiments, the user interface includes a real time map, showing a current machine location, a machine status, or the like. In some embodiments, the user interface includes a color coded warning indicator, an audible alarm, or another indicator structured to communicate to the user that the work machine is in a location or state that requires the attention of the user or operator (e.g., the work machine's rental period has expired, the work machine is located in an undesignated area off of a work site which may warrant changing access controls to prevent unauthorized use, etc.).

In some embodiments, the system for controlling access to work machines is configured to send instructions to work machine connectivity modules to illuminate a light or generate a sound, either with a beacon integrated into the connectivity module or with the lights and horn of the machine itself, responsive to a user interaction with an application (e.g., an “access control” application). The system for controlling access to work machines assists users in locating a machine from among a group of machines on a work site through remote activation of visible and audible indicators on the machine (e.g., users enter commands on the “access control” application to activate a beacon on a particular machine to distinguish it from a group of physically similar machines on a work site, to alert operators that a particular machine has limited functionalities, etc.). Additionally, a work machine's lights and horn may be activated by the system for controlling access to work machines. In a further example, a beacon may be provided as a component of the system for controlling access to work machines. In another example, the system for controlling access to work machines may generate a user interface with a dynamic filter of a map to illustrate a total machine population. The user interface may also enable a remote user to apply such a filter to a specific jobsite network much the same as can be done locally via the mobile app.

In some embodiments, a system for controlling access to work machines may include work machines configured with connectivity modules that may illuminate lights or generate sounds with a beacon or with the horn and lights of the machine itself when a user interacts with an application (e.g. an “control access” application, an “disable work machines” application, etc.). The system for controlling access to work machines may visually or audibly identify machines in a user selected group of machines at a work site. Using the beacons on the machines or the lights and horns of the machines, several machines can be identified at a time both digitally in an application and on the machine itself. The system for controlling access to work machines allows a user to pick a machine physically and tie it to the digital version of the machine stored in the system or in a local fleet connectivity system enabled to operate with a system for controlling access to work machines. The system for controlling access to work machines may save time searching for serial numbers and matching them to machines and documents. In another example, the system for controlling access to work machines may use beacon lights and beep the horns of machines in a group of machines at a work site to differentiate one machine from another based on which machine has limited functionalities, which machine has had its access criteria regulated via the system, etc. A user may use the system for controlling access to work machines to limit the use of local machines to those with the required credentials (e.g., only operators with specific training/documentation may use machine number 5). A user may also use the system for controlling access to work machines to limit the functionality of assets according to a user defined criteria (e.g. lock one or more machines on low speed mode, enable full functionality on machines that have a full charge, disable all functionalities on a machine with faults). A user may also use the system for controlling access to work machines to designate specific individuals who are authorized to regulate access controls or are not authorized to regulate access controls (e.g., site managers may enable and disable access regulations while other operators cannot, etc.).

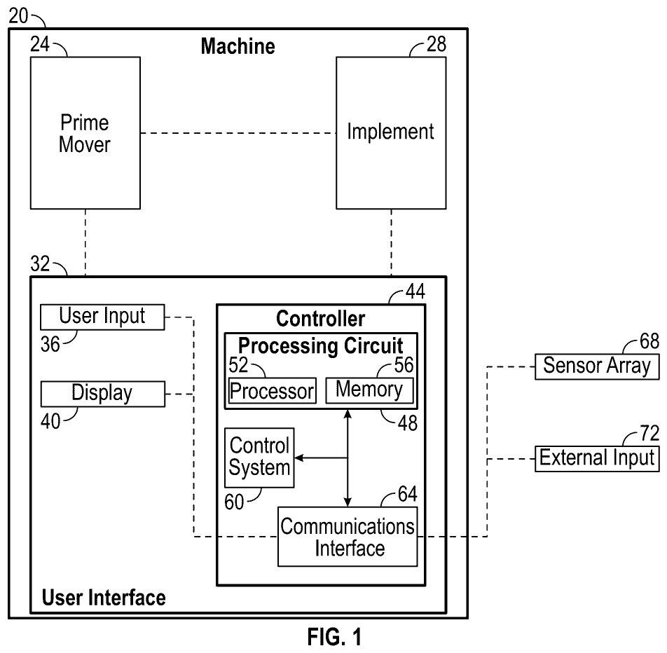

As shown in FIG. 1, a work machine 20 (e.g., a telehandler, a boom lift, a scissor lift, etc.) includes a prime mover 24 (e.g., a spark ignition engine, a compression ignition engine, an electric motor, a generator set, a hybrid system, etc.) structured to supply power to the work machine 20, and an implement 28 driven by prime mover 24. In some embodiments, the implement 28 is a lift boom, a scissor lift, a telehandler arm, etc.

A user interface 32 is arranged in communication with the prime mover 24 and the implement 28 to control operations of the work machine 20 and includes a user input 36 that allows a machine operator to interact with the user interface 32, a display 40 for communicating to the machine operator (e.g., a display screen, a lamp or light, an audio device, a dial, or another display or output device), and a control module 44.

As the components of FIG. 1 are shown to be embodied in the work machine 20, the controller 44 may be structured as one or more electronic control units (ECU). The controller 44 may be separate from or included with at least one of an implement control unit, an exhaust after-treatment control unit, a powertrain control module, an engine control module, etc. In some embodiments, the control module 44 includes a processing circuit 48 having a processor 52 and a memory device 56, a control system 60, and a communications interface 64. Generally, the control module 44 is structured to receive inputs and generate outputs for or from a sensor array 68 and external inputs or outputs 72 (e.g., a load map, a machine-to-machine communication, a fleet management system, a user interface, a network, etc.) via the communications interface 64.

The control system 60 generates a range of inputs, outputs, and user interfaces. The inputs, outputs, and user interfaces may be related to a jobsite, a status of a piece of equipment, environmental conditions, equipment telematics, an equipment location, task instructions, sensor data, equipment consumables data (e.g. a fuel level, a condition of a battery), status, location, or sensor data from another connected piece of equipment, communications link availability and status, hazard information, positions of objects relative to a piece of equipment, device configuration data, part tracking data, text and graphic messages, weather alerts, equipment operation, maintenance, and service data, equipment beacon commands, tracking data, performance data, cost data, operating and idle time data, remote operation commands, reprogramming and reconfiguration data and commands, self-test commands and data, software as a service data and commands, advertising information, access control commands and data, onboard literature, machine software revision data, fleet management commands and data, logistics data, equipment inspection data including inspection of another piece of equipment using onboard sensors, prioritization of communication link use, predictive maintenance data, tagged consumable data, remote fault detection data, machine synchronization commands and data including cooperative operation of machines, equipment data bus information, operator notification data, work machine twinning displays, commands, and data, etc.

The sensor array 68 can include physical and virtual sensors for determining work machine states, work machine conditions, work machine locations, loads, and location devices. In some embodiments, the sensor array includes a GPS device, a LIDAR location device, inertial navigation, or other sensors structured to determine a position of the equipment/work machine 20 relative to locations, maps, other equipment, objects or other reference points.

In one configuration, the control system 60 is embodied as machine or computer-readable media that is executable by a processor, such as processor 52. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the control system 60 is embodied as hardware units, such as electronic control units. As such, the control system 60 may be embodied as one or more circuitry components including, but not limited to, processing circuitry, network interfaces, peripheral devices, input devices, output devices, sensors, etc. In some embodiments, the control system 60 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the control system 60 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The control system 60 may also include programmable hardware devices such as field programmable gate arrays, programmable array logic, programmable logic devices or the like. The control system 60 may include one or more memory devices for storing instructions that are executable by the processor(s) of the control system 60. The one or more memory devices and processor(s) may have the same definition as provided below with respect to the memory device 56 and processor 52. In some hardware unit configurations, the control system 60 may be geographically dispersed throughout separate locations in the machine. Alternatively, and as shown, the control system 60 may be embodied in or within a single unit/housing, which is shown as the controller 44.

In the example shown, the control module 44 includes the processing circuit 48 having the processor 52 and the memory device 56. The processing circuit 48 may be structured or configured to execute or implement the instructions, commands, and/or control processes described herein with respect to control system 60. The depicted configuration represents the control system 60 as machine or computer-readable media. However, as mentioned above, this illustration is not meant to be limiting as the present disclosure contemplates other embodiments where the control system 60, or at least one circuit of the control system 60, is configured as a hardware unit. All such combinations and variations are intended to fall within the scope of the present disclosure.

The hardware and data processing components used to implement the various processes, operations, illustrative logics, logical blocks, modules and circuits described in connection with the embodiments disclosed herein (e.g., the processor 52) may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., control system 60 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device 56 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device 56 may be communicably connected to the processor 52 to provide computer code or instructions to the processor 52 for executing at least some of the processes described herein. Moreover, the memory device 56 may be or include tangible, non-transient volatile memory or non-volatile memory. Accordingly, the memory device 56 may include database components, object code components, script components, or any other type of information structure for supporting the various activities and information structures described herein.

In an exemplary embodiment, the memory device 56 stores instructions for execution by the processor 52 for a process to automatically generate a work site equipment grouping. The process to automatically generate a work site equipment grouping automatically associates machines 20 connected on a near a network to one or more other machines 20. In some embodiments, the automatic associations are based on association rules stored on a work machine or on another network node. In some embodiments, the association rules are based on one or more of a work site designation, a location of a machine, or a code (e.g. a customer key, a manufacturer key, or a maintainer key). The system for controlling access to work machines may interoperate with the process to automatically generate work site equipment groupings. For example, the automatically generated equipment groupings might be communicated to the system for controlling access to work machines and automatically populate therein for selection by a user (e.g., upon starting the system, the user may select the automatically generated grouping and toggle/revise/modify access controls or functionalities for that equipment group without having to manually create/select the machines in the group).

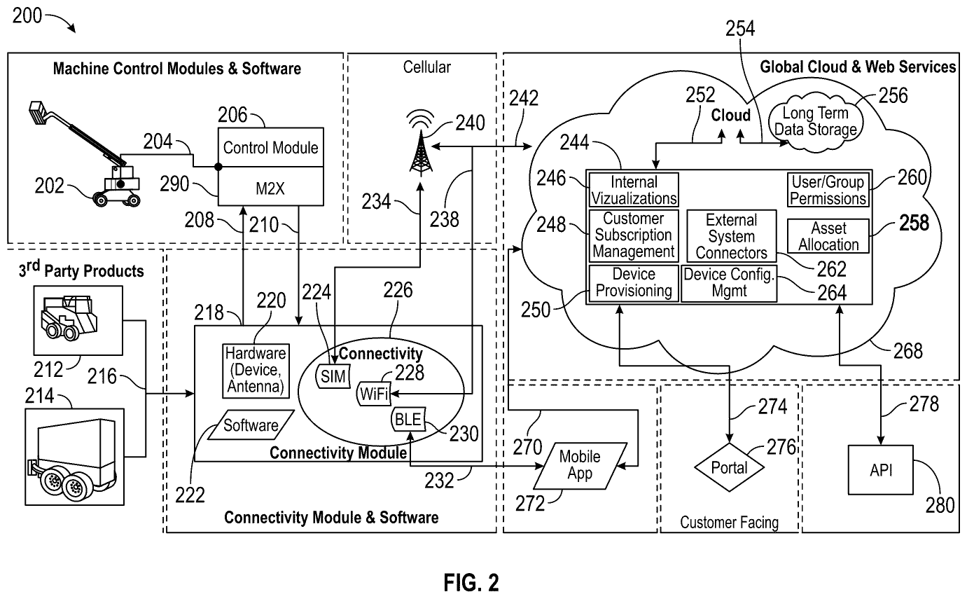

As shown in FIG. 2, the system for controlling access to work machines may interoperate with a local fleet connectivity system 200 supported by a network of nodes. The network of nodes may include one or more work machines 202, each with a control module 206, one or more connectivity modules 218, and one or more network devices hosting, for example, user devices 272 including user interfaces, network portals 276, application interfaces/application programming interfaces 280, data storage systems 256, cloud and web services, and product development tool and application hubs 244. A user of the system for controlling access to work machines may regulate access to specific work machines, limit the functionalities of certain work machines, etc. by issuing commands on the system that are then relayed, transmitted, broadcast, etc. via the local fleet connectivity system 200 or one or more nodes of the local fleet connectivity system 200.

The work machine 202 is communicably connected to a control module 206. The connection 204 between the work machine 202 and the control module 206 may be wired or wireless thus providing the flexibility to integrate the control module with the work machine 202 or to temporarily attach the control module 206 to the work machine 202. The control module 206 may be configured or may be reconfigurable in both hardware and software to interface with a variety of work machines 202, 212, 214 via the connectivity module 218. The control module 206 may comprise an integral power source or may draw power from the work machine 202 or another external source of power. Control modules 206 may be installed on or connected, e.g., via a connection 216, to products (e.g., third party products 212, 214) not configured by the original product manufacturer with a control module 206.

The work machine 202 communicably connects to the system for automatic generation of worksite equipment groupings via a machine-to-X (M2X) module 290. The M2X module 290 is communicably connected to the control module 206. The M2X module 290 establishes one or more communications channels 208, 210 with a connectivity module 218. The connectivity module 218 provides a plurality of links between one or more work machines 202, 212, 214 and the local fleet connectivity system 200. Applications providing functions for the local fleet connectivity system 200 may be run by the M2X modules on one or more work machines 202. One or more user devices 272 may be configured to communicate (e.g., to exchange commands, codes (e.g. a customer key) and data) with the connectivity modules of one or more machines via a network connection, for example via a local wireless connectivity system or via a cellular networks (e.g., via cell towers 240) to form a network of interconnections among machines, devices, or nodes. Connections between machines and user devices in the local fleet connectivity system may be provided by a wireless mesh network, for example. A user of the system for controlling access to work machines may view each asset connected on the network (for example, via a web interface, mobile application, etc.) and remotely lock one or more work machines, disable equipment, limit the functionalities of equipment, enable full functionality of certain equipment, toggle operators ability to access and regulate access to equipment, etc.

The connectivity module 218 comprises hardware 220, further comprising antennas, switching circuits, filters, amplifiers, mixers, and other signal processing devices for a plurality of wavelengths, frequencies, etc., software hosted on a non-volatile memory components 222, and a communications manager 226. The communications manager 226 may comprise processing circuits with communications front ends 224, 228, and 230 for one or more signal formats and waveforms including, for example, Bluetooth, Bluetooth low energy, Wi-Fi, cellular, optical, and satellite communications. The connectivity module 218 may function as a gateway device connecting work machine 202 to other work machines 212, 214, remote computing systems 244, 272, 276, and 280, beacons, scheduling or other fleet management and coordination systems like the system for controlling access to work machines.

In some embodiments, communication each work machine may be encrypted or require a code, key, or command to access (e.g., encrypted BLE data may require decryption to facilitate communication with or access to the machine). The system for control access to work machines generates an “owner key” and a “rental key” for each work machine. For example, such keys may decrypt and allow communication to the machine (e.g., via BLE commands, etc.). Keys may be time sensitive. For example, owner keys created by the system for controlling access to work machines may be permanent (e.g., one in possession of an owner key may have unlimited access to the machine, may not have their communications to the machine limited, may have full access to the machine's functionalities, etc.). Rental keys, however, may expire after a designated period of time (e.g., no longer effective to access or decrypt communications with the machine after one week). Rental keys and owner keys may be passwords that allow access to the machines, applications that interact with the machines, etc. Keys created by the system for controlling access to machines may also allow access to mobile applications, web portals, and user devices associated with the respective machine.

In other embodiments, the system for controlling access to work machines may include hardware, software, code, etc. on the work machines in place of owner or rental keys. For example, rather than a keypad or hardware on the work machine to facilitate operation, activate the machine, etc., the work machine may be activated wirelessly via communications with an application, user device, or profile that has been granted access to use the machine (e.g., WiFi communication, BLE communication, etc. to communicate and unlock the machine). In this way, the system for controlling access to work machines may allow wireless communications, mobile applications, and the like to replace physical keypads, RFID readers, or other hardware installed on the machine.

The local fleet connectivity system 200 allows for the coordination of multiple machines 202, 212, 214 within the same work site, or a fleet wide control. Such fleet wide control may interoperate with the system for controlling access to work machines. For example, a work machine 202 may remotely report the results of a self-inspection to a user via a user device 272. Further, the system and/or a user of the system for controlling access to work machines may limit the functionalities of the work machine based on the result of the self-inspection (e.g., lock the machine to low speed mode if the self-inspection yields warning signs, faults, low battery, or the like). The system or a user of the system for controlling access to work machines may also issue uniform access controls or vary access controls fleet-wide, by work site, work site grouping, machine grouping, individual machine, individual machine system, etc.

The local fleet connectivity system 200 provides connectivity between work machines 202, 212, 214 and remotely hosted user interfaces 272, network portals 276, application interfaces/application programming interfaces 280, data storage systems 256, cloud and web services 268, and product development tool and application hubs 244 that function as an Internet of Things (IOT) system for operation, control, and support of work machines 202, 212, 214 and users of work machines. Connections 232, 234, 238, 242, 252, 254, 270, 274, and 278 between nodes connected to the local fleet connectivity system 200 may comprise, for example, cellular networks, or other existing or new means of digital connectivity.

Product development tool and application hubs 244 may comprise tools and applications for internal visualizations 246, customer subscription management 248, device provisioning 250, external systems connectors 262, device configuration management 264, user/group permissions 260, asset allocation 258, fleet management, compliance, etc. The system for controlling access to work machines may directly or indirectly manage, alter, revise, or edit data associated with these tools and applications (e.g., remotely establish user groups approved to use all functionalities of various machines, establish permissions for various other users to regulate machine access, set requirements for operators seeking to use certain functionalities of certain machines, etc.).

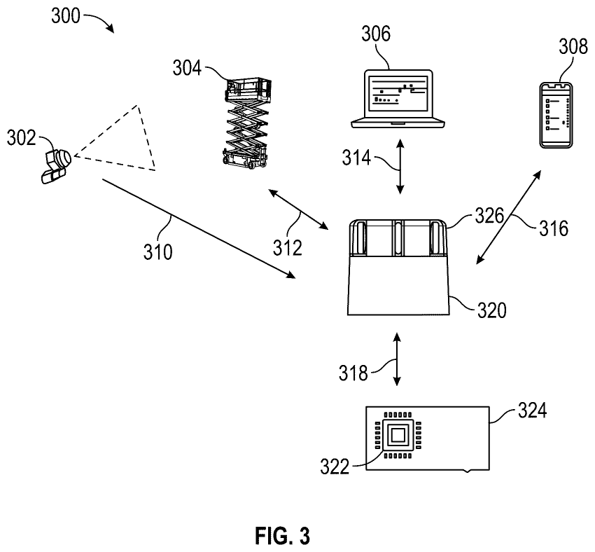

FIG. 3 shows a local fleet connectivity system 300 according to an exemplary embodiment. As shown in FIG. 3, the connectivity module 320 functions as a communications interface between a control system 322 of the work machine 324 and other elements connected to the local fleet connectivity system 300 (e.g., the system for controlling access to work machines). The connectivity module 320 may be part of the work machine 324 or may be physically coupled to the work machine 324. The connectivity module 320 may exchange commands and data 318 with the control system 322 of the work machine 324, sensor data 310 with auxiliary sensors 302, machine data 312 with another machine 304, commands and data 314 with a node or portal (e.g., remote computing device 306), and commands and data 316 with a user device 308 running an application for the local fleet connectivity system 300. The connectivity module 320 may exchange commands, codes (e.g., a customer key) and data between work machines 304, 324, user devices 308, and/or remote computing devices 306 to form a network of interconnections among machines, devices, or nodes. Further, the connectivity module 320 may exchange commands and data with the system for controlling access to work machines and allow the system to vary the functionalities of an individual machine, toggle certain systems of the machine on or off, activate the beacons, lights, horn of the machine, set certain speed thresholds for various functions on the machine, etc.

In some embodiments, in response to a user selection on an application related to the system for controlling access to work machines hosted on the user device 308, one or more machines can be located and/or identified by one or both of a visual or audible signal from the selected machine or from the connectivity module coupled to the machine. For example, the connectivity module 320 may also include and/or function as a beacon 326 that may include one or both of a light or sound generator and may be configured to identify a machine by generating one or both of a visual or audible signal (e.g., alerts, indications, etc.). The connectivity module 320 may, for example, include a beacon 326 that includes a light (e.g., an RGB LED light) which is lit when a user presses a button on an application (e.g., an identify-my-machine application on a user device 308). Additionally or alternatively, the connectivity module 320 may be communicatively coupled to one or more lights (e.g., headlights, cabin lights, etc.) of the work machine 324 (e.g., via the control system 322) and can instruct the lights to generate the visible signals in response to the selection of a button on the user device 308. For example, a machine that has had its access controls altered and locked to “tow mode” may flash or show a constant yellow light. A machine that has a credential requirement put in place before full functionality may be accessed may flash a green light or initiate an audio cue upon receiving the appropriate credentials. A machine that has its rental time expire and will be locked into tow mode or low speed mode upon being turned off may also light up, flash, etc. based on the upcoming change in access controls to alert operators of the change. The beacon 326 may additionally or alternatively include a speaker to provide the audible signals. Additionally or alternatively, the connectivity module 320 may be communicatively coupled to a horn of the work machine 324 (e.g., via the control system 322) and can instruct the horn to sound to generate the audible signal in response to the selection of a button on the user device 308. The visual and audible signals can be used in conjunction or independently of one another. The beacon 326 may emit any or all combinations of frequency, color, patterns etc. of light and may emit any sound or message (e.g., recorded or computer generated speech). The connectivity module 320 may be a self-contained unit. For example, the connectivity module 320 may be installed on or connected to machines not configured by the original product manufacturer with a connectivity module 320 and may be configured to communicate with the control module of the machine.

The local fleet connectivity system 300 may, for example dynamically filter a user interface map to illustrate a total machine population connected to the system for controlling access to work machines. In a further example, a remote user may apply a filter to a specific work site network, much the same as can be done locally, via a mobile application. This allows a remote user to apply the desired user configurable rules, access controls, functionalities controls, etc. to assist a local user that does not have access to a user interface of the local fleet connectivity system 300 or the system for controlling access to work machines. In some embodiments, the beacon 326 on the connectivity module 320 may include a light that may be used to illustrate or illuminate various machine statuses (e.g., fuel level, battery level, maintenance status, ignition on/off, in operation, full control authorized, machine disabled, machine locked to transport mode, etc.). For example, the light on the beacon 326 may be green when full machine functionality is enabled and red when the machine is locked. An application on a user device 308 can be used as an interface for a user to select which status they want to be displayed on a fleet within the connected range (e.g., distance, selected area, etc.) of a user device. The user may selectively command the beacons of one or more machines within the selected range to indicate the status or condition of the associated machine. For example, a user may select an option that turns the light green on machines that are to be used or have full functionality and turns the light red on machines that are not to be used, have functionalities disabled, are locked in reduced speed or transport mode, etc. In some examples, selections may be independent of or in conjunction with the filter criteria of a desired subset of a fleet. In some embodiments, the user device 308 may be configured to send a command to the connectivity module 320 of a selected machine to power up or power down the machine. In some embodiments, the user device 308 may be configured to send a command to the connectivity module 320 of a selected machine to enable or disable operation of the machine, functionalities related to the machine, etc. For example, in response to a user selection on an application hosted on the user device 308, one or more machines can be located and/or identified by one or both of a visual or audible signal from the selected machine or from the connectivity module coupled to the machine. In some embodiments, the connectivity module 320 may include one or both of a light or sound generator and may be configured to identify a machine by generating one or both of a visual or audible signal (e.g., alerts, indications, etc.). For example, the connectivity module 320 may include a beacon 326 with a light (e.g., an RGB LED light) which is lit when a user presses a button on an application (e.g., an identify-my-machine application on a user device 308). Additionally or alternatively, the connectivity module 320 may be communicatively coupled to one or more lights (e.g., headlights, cabin lights, an incandescent light, a light emitting diode, a fixed beacon, a flashing beacon, a rotating beacon, a laser, a light array, etc.), display devices, or markers, etc. of the work machine 324 (e.g., via the control system 322) and can instruct the lights, devices, markers, etc. to generate the visible signals in response to the selection of a button on the user device 308. The beacon 326 may additionally or alternatively include a speaker to provide the audible signals. Additionally, or alternatively, the connectivity module 320 may be communicatively coupled to a horn or speaker of the work machine 324 (e.g., via the control system 322) and can instruct the horn or speaker to generate the audible signal in response to the selection of a button on the user device 308.

In some embodiments, the local fleet connectivity system 300 and/or the system for controlling access to work machines may allow a user to identify and regulate access controls for multiple machines of a plurality of machines. Each machine may include a connectivity module 320 that is part of or physically coupled to the machine (e.g., machine 324). The connectivity module may be communicatively coupled to the control system 322 of the machine and may be configured to communicate with the other connectivity modules via a network connection. A user may use a user device (e.g., user device 308) configured to communicate with the one or more connectivity modules via a network connection. A user may make selections of machines using an application on the user device. In response to the selection, the selected machines can be regulated, locked in certain functionalities, enabled/disabled, identified by one or both of an audible signal or a visual signals, etc. For example, if a user selects work machines 304 and 324 via the user device 308, the user may regulate, alter, or revise the access controls for work machines 304 and 324. For example, regulating, altering, or revising the access controls may include designating that work machines 304 and 324 are to be locked in tow mode, remain in transport mode, locked in low speed mode, that certain sub-systems of work machines 304 and 324 are to cease operation or be enabled, that work machines 304 and 324 may only be accessed by individuals with certain training/credentials/added to permission groups, that work machines 304 and 324 are allowed to operate in a full power mode until a certain low power threshold is reached, that the work machines are to be inoperable between certain designated hours, that the work machines are to be only operable in tow mode in defined geographic locations, that a designated keycode may be used to access the work machines, etc. Further, work machines 304 and 324 may generate an audible or visual signal using their respective horns, headlights or a machine state visual indicator coupled to the respective connectivity unit to indicate their respective access control settings. In some embodiments, each machine is identified by a different visual or audible signal. For example, if the connectivity modules of the two or more machines each comprise a light configured to illuminate to generate the visual signal, the light of each connectivity module of the two or more machines may illuminate with a different color. In other embodiments, each machine's current access control settings are identified by a different visual or audible signals. For example, if the connectivity modules of the two or more machines each comprise a light configured to illuminate to generate the visual signal, the light of the connectivity module of a machine with full functionalities enabled may illuminate with a different color/pattern/etc. than a machine with limited functionalities enabled, locked in tow mode, etc.

In some embodiments, the user of the system for controlling access to work machines may make a selection of machines by dynamically filtering the plurality of machines according to one or more selectable attributes or criteria. The selectable attributes or criteria may include, for example, one or more of a machine type, a battery status, a machine model number, a machine manufacturer, a machine location, a machine work site tag, a machine status, a repair status, a DTC status, a fuel status, a use status, or the number of other machines that must be used to access or move a machine. In some embodiment, the user device displays a map showing the locations of the plurality of machines. Machines that do not match the filter criteria may be temporarily removed from the map.

In some embodiments, a plurality of connectivity modules illuminates the beacons 326 attached to a plurality of work machines responsive to a command from a remote user device communicatively connected to the plurality of connectivity modules via a wireless connection. In some embodiments, the plurality of lights attached to the plurality of work machines are illuminated simultaneously in response to a single command from the remote user device. In some embodiments, the local fleet connectivity system and/or the system for controlling access to work machines generates commands to a plurality of work machines designated by a user interacting with the local fleet connectivity application hosted on a user device to activate lights or audible indicators and electronically pair a work machine selected by a user from the plurality of work machines with a digital model of the selected work machine generated by the local fleet connectivity application on the user device. For example, a user may observe a group of work machines at work site. The user may command a subset of the group of work machines to activate lights on or attached to the work machines using an application on a user device (e.g., a “find me” application). The user may, through the user application, designate the subset of work machines to be identified based on criteria selected through the application. Through the application and user device connected to work machines on the local fleet connectivity network 300, the user may activate lights, horns or other indicators on several different work machines and may select variations on lights (e.g., different colors, different patterns, different intensities, etc.) to distinguish between machines and quickly identify the desired machine or group of machines (e.g., “find me” commands to multiple machines at the same time). The application provides options for a user to identify a machine physically (through observation of the light or a horn) and tie the identified machine to the digital model of the same machine generated by the application on the user device. For example, a user may tie a selected machine or group of machines identified physically by the user using the “find me” indications with a digital record for the machine (including serial number, service records), and access connected services for the machine available through the local fleet connectivity system (e.g., location, electronic commerce, use tracking, billing, maintenance support, etc.). Further, the user may use the system for controlling access to work machines regulate access controls for the identified machines. In a further example, a user may apply additional criteria to machine identification commands. For example, a user input to the application criteria for machine states or conditions (e.g., fully charged, at least ½ fuel, no outstanding service issues, no faults detected on self-test, etc.), machine type (e.g., specific make, specific model, etc.), machine location (e.g., proximity to the user, proximity to a task, positioned for easiest movement out of a staging area, etc.). The provisions within the local fleet connectivity application and network for physically identifying machines and tying them to matching digital models including full digital machine records provides significant savings of time searching machines and manually confirming records (e.g., machine serial numbers). In a further example, a user may simultaneously communicate with a plurality of machines (e.g., directly using a mesh, Wi-Fi, or other local connection or remotely via a cloud network connection) that satisfy one or more selected criteria (e.g., machines that are the same model) and command them via the local fleet connectivity application to separately identify themselves (e.g., with different color lights). The user may then select the “green machine” indicated via the application user interface, the machine may flash its lights to indicate “this one” and the user can then tap an indicator in the application to verify machine selection and electronically pair a user device with that machine. The user may then access or enter information for selected machines and share the information with other devices connected to the local fleet connectivity system through the application.

In some embodiments, the local fleet connectivity system 300 allows for the coordination of multiple machines 304, 324 within the same work site, or a fleet wide control. For example, if a first work machine 304 is required to accomplish a task collaboratively with a second work machine 324, a user interacting with a user device 308 may provide commands to the first work machine 304 and second work machine 324 to execute the task in collaboration. In some embodiments, the local fleet connectivity system 300 is an application hosted on one or more processors connected to the local fleet connectivity system 300. In some embodiments, the system for automatic generation of a work site equipment grouping may automatically associate machines 304, 324 that are connected on a local area network to one another. In some embodiments the equipment grouping system may transmit this information to the cloud 314 for data processing and for simple fleet management. In other words all machines on a particular job-site could easily be identified and accessed and grouped by site. The system for controlling access to work machines may interoperate with these machine groupings to set permissions, regulate controls, enable/disable functionalities, etc. Notifications could also be used to alert persons with the correct permissions when machines are checked in or out. In some examples, the equipment grouping system may provide measures to prevent unauthorized physical and electronic access to machines (e.g., anti-hacking applications, key codes, etc.). In some examples, the equipment grouping system resets a grouping of equipment when a machine in the group goes into a selected or defined mode (e.g., tow mode, etc.). In some examples, the equipment grouping system is communicably connected to an electronic commerce system or enterprise resource planning system (e.g., integration into work machine rental contracts for time and location based inputs derived from system equipment/work machine data).

Further referring to FIG. 3, in some embodiments, the system for controlling access to work machines may comprise electronic commerce functions accessible via the work machine. In some examples, electronic commerce functions are accessed through a tab or page within the application or on the work machine's control module/user interface/etc., a click-through popup within the application, a scrolling banner within the application, a push notification, etc. In some examples, the electronic commerce functions provided through the local fleet connectivity system 300 may be managed by an electronic commerce application hosted on a controller installed in a machine 304, 324 or a user device 308. Electronic commerce functions provided through the system for controlling access to work machines may include for example, re-purchasing functionalities that have been locked or disabled via an interface on the work machine, extending rental time or access to certain permissions, purchasing access to certain functionalities or systems of a machine, etc. In this way, the system may receive a signal configured to re-enable a disabled functionality or system of a work machine upon satisfaction of a condition such as the payment of a fee, the extension of rental time, receipt of a confirmation code indicating that access credentials have been returned, etc.

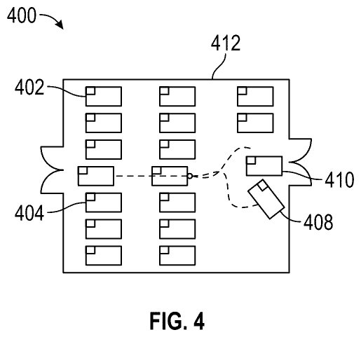

As shown in FIG. 4, the local fleet connectivity system 400 may be deployed at a work site 412 to control a fleet of work machines 402, 404, 408, 410 via the connectivity module 406 to collaboratively perform tasks requiring more than one work machine 408, 410. For example, a user may wish to move the work machine 410 from its stored position on the left of the work site 412 out the door on the right of the work site. The connectivity module may communicate with both the work machine 408 and the work machine 410, causing the work machine 408 to move out of the way of the work machine 410, so that the work machine 410 can move past the work machine 408 and out the doorway.

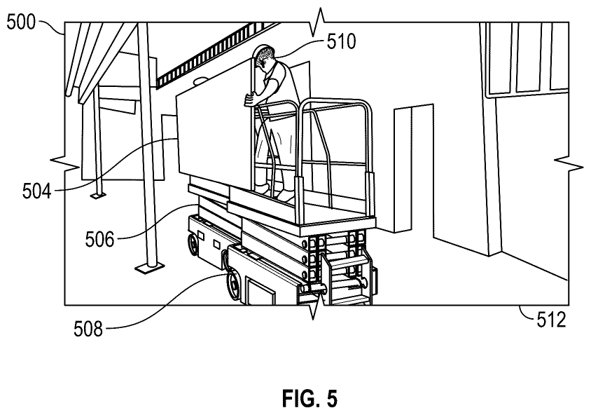

As shown in FIG. 5, a plurality of work machines 506, 508 connected to local fleet connectivity system 500 may collaboratively perform tasks on a jobsite 512 requiring more than one work machine, for example emplacing a section of drywall 504 that is too large to be handled by a single work machine. A user device may communicate with both the work machine 506 and the work machine 508 and cause them to move at the same speed and in the same direction so that a user 510 on each machine 506, 508 can hold the drywall 504 while the machines 508, 510 are moving. Connectivity between the machines 508, 508 and with the local fleet connectivity system 500 can prevent the machines 508, 510 from being separated so that the users 510 do not drop the drywall 504.

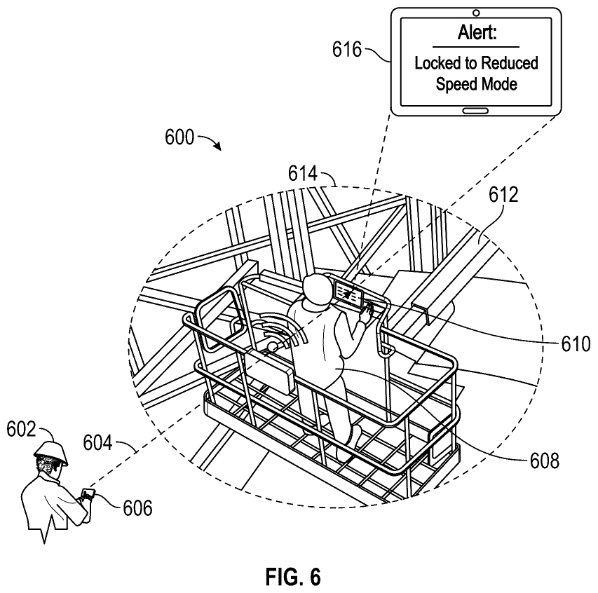

As shown in FIG. 6, a remote user 602 of a system for controlling access to work machines 600 can send messages, data, and commands 604 from a remote device 606 to a work machine 612 operated by an onsite user 608 on a jobsite 614. The messages, data, and commands 604 may be received by the control system 610 of a work machine 612 and notifications related to the messages, data, and commands may be displayed via a user interface on an onboard display 616. The remote user 608 may alter the access control parameters associated with the work machine 612 being used by the onsite user 608. For example, the remote user 608 may use the system for controlling access to work machines to view all assets and work machines connected to a local connectivity system via a web interface or mobile application. The remote user 608 may manually select the work machine 612 to edit, revise, or toggle its access control settings. In some embodiments, the system for controlling access to work machines automatically selects work machine 612 based on its presence in a predefined group or based on other criteria (e.g., the system detects that work machine 612 is low on battery, is subject to a rental period that is about to expire, self-reported a status that warrants immediate cease of operations, etc.). The remote user 608 may activate a function or issue a command on an interface of the remote device 606 to disable work machine 612, lock work machine 612, place/lock work machine 612 into reduced speed mode, place/lock work machine 612 into transport or tow mode, conditionally lock work machine 612 into tow mode (e.g., work machine 612 will be locked into tow mode, but only after it next powers down), or perform variations, combinations, or other like asset control functionalities remotely. Upon having its access control parameters altered, a signal on the onboard display 616 informs the onsite user 608 of the control changes made to work machine 612. For example, as shown in FIG. 6, the remote user 602 may lock work machine 612 into reduced speed mode (or transport mode, where boom cannot return to use height) because the rental period has expired. A message may inform the onsite user 608 of the change in status. Notifications may displayed for the onsite user 608 on the onboard display 616. This allows the onsite user 608 to receive and view the control settings without the need to call the remote user 602 or write the settings/access parameters down. Because the work machine 612 is connected to the remote device 606 (e.g., via a connectivity module 218) the remote user 602 may receive the location of the work machine 612, as well as other work machines on the jobsite 614, and may use the location information to determine the other asset control regulations/changes to the asset control regulations to send.

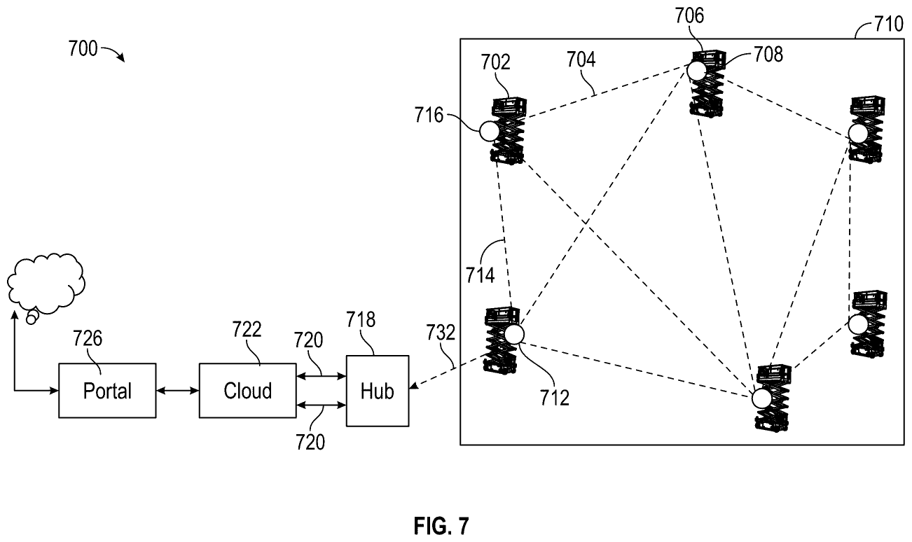

Referring to FIG. 7, a local fleet connectivity system 700 includes a connectivity hub 718. In some embodiments, the connectivity hub includes a connectivity module. In some embodiments, the connectivity hub is configured to communicatively connect with one or more connectivity module equipped machines 702, 706 in proximity to the connectivity hub 718. In some embodiments, the connectivity hub is configured to broadcast a work site identification signal. In some embodiments, the connectivity hub is configured to connect work site machines 702, 706 connected to the local fleet network to an external internet feed 720. In some configurations, the connectivity hub is configured as a gateway to one or more communications systems or network systems to enable exchanges of data 720, 722 between nodes 708, 712, 716 on the work site 710 local fleet connectivity mesh network 704, 714, 732 and nodes 726 external to the work site.

In some embodiments, connectivity hub has a connectively module that (a) provides the functionalities described here in place of or in addition to a machine that has a connectivity module, (b) broadcasts a site identifier, or (c) connects to an external internet to flow through data to and from the jobsite that is provided across the mesh.

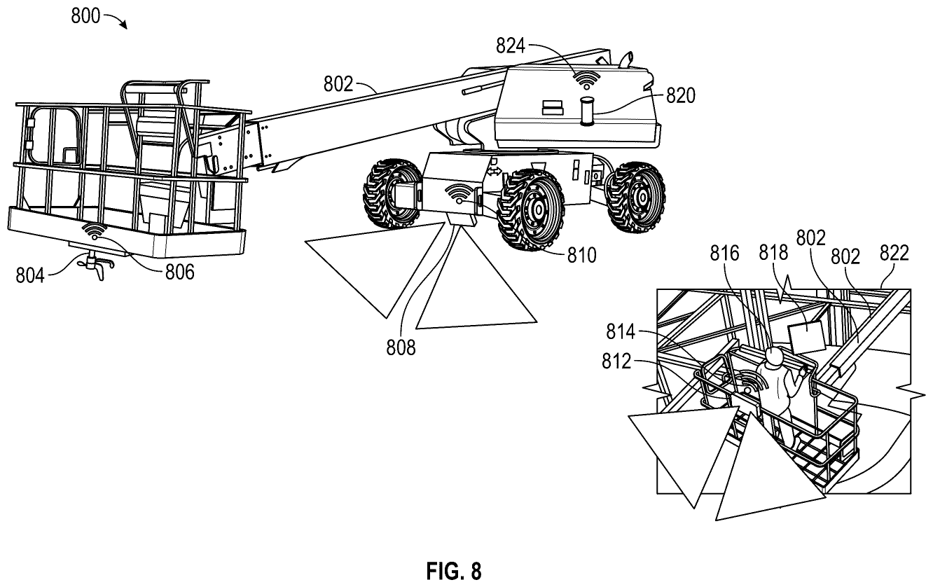

Referring to FIG. 8, a sensor network system 800 is shown. Sensors 804, 808, 812, 820 may be coupled to a work machine 802 on a jobsite 822. The sensors may be, for example, object detection sensors 808 812, environmental sensors 804 (e.g., wind speed, temperature sensors), and tagged consumable sensors 820. The sensors 804, 808, 812, 820 may be connected to and may send data to an equipment identification system via wireless connections 806, 810, 814, 824. The sensor data may displayed or may be used to generate messages for display on an onboard display 818 for a user 816 of the work machine 802. The onboard display 818 may receive the sensor data via a direct wired or wireless connection to the sensors. Alternatively the sensors may communicate with the onboard display through the equipment identification system (e.g., via a connectivity module 218). Sensor data from various work machines may be combined to map the jobsite 822 and to determine if environmental conditions are safe for using the work machines. Sensor data from the tagged consumable sensors 820 may be used to determine, for example, when tagged consumables must be replaced. The system for controlling access to work machines may be used to disable or enable certain sensor systems, regulate which users may access certain sensor systems, etc.

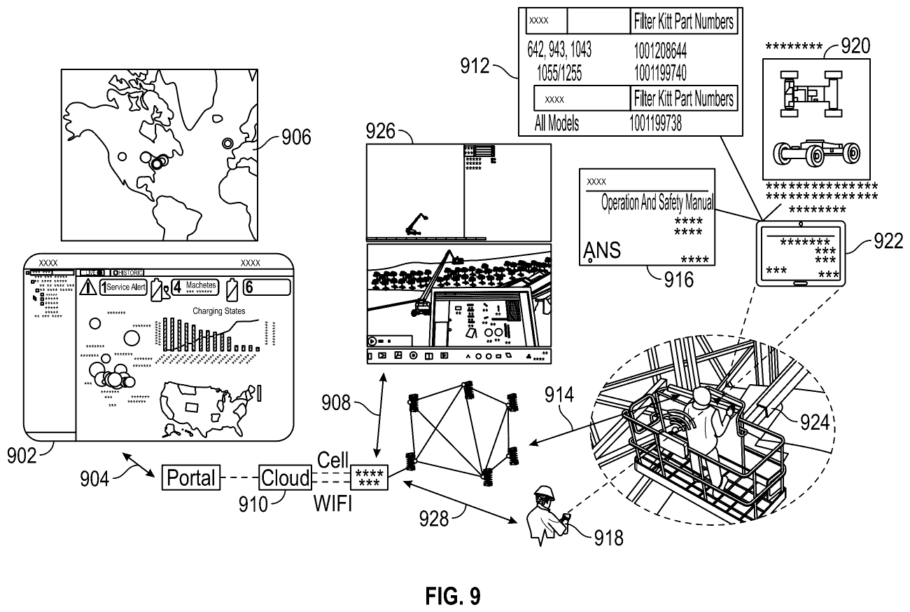

As shown in FIG. 9, various user interfaces are available to be displayed on a remote user device 918 and an onboard display 922 of a work machine 924. A connectivity hub 910 may send and receive data 928, 908, 904 914 including the user interfaces 902, 906, 912, 916, 926, 920. The user interface 906 is a heatmap of locations of a plurality of work machines. The user interface 902 is a machine status display that shows the battery level, location, and alerts relating to a plurality of work machines. User interface 926 shows a digital twin of a work machine that updates based on sensor data of an associated work machine. User interface 912 is a list of part numbers for the work machine 924. User interface 916 is an operation and safety manual for the work machine 924. User interface 920 is a detailed schematic of the work machine 924.

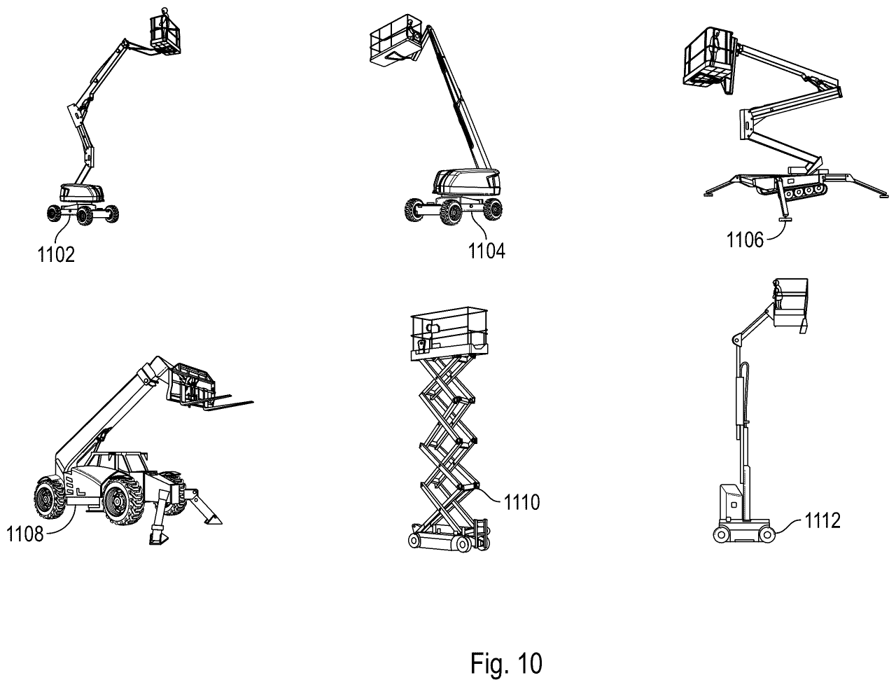

As shown in FIG. 10, the boom of telescoping boom lift 1104 includes a first boom section (e.g., lower boom, etc.) and a second boom section (e.g., upper boom, etc.). In other embodiments, the boom includes a different number and/or arrangement of boom sections (e.g., one, three, etc.). According to an exemplary embodiment (e.g., articulating boom lift 1102), the boom is an articulating boom assembly. In one embodiment, the upper boom is shorter in length than lower boom. In other embodiments, the upper boom is longer in length than the lower boom. According to another exemplary embodiment, the boom is a telescopic, articulating boom assembly. By way of example, the upper boom and/or the lower boom may include a plurality of telescoping boom sections that are configured to extend and retract along a longitudinal centerline thereof to selectively increase and decrease a length of the boom.

As shown in FIG. 10, the lower boom of telescoping boom lift 1104 has a first end (e.g., base end, etc.) and an opposing second end (e.g., intermediate end). According to an exemplary embodiment, the base end of the lower boom is pivotally coupled (e.g., pinned, etc.) to the turntable at a joint (e.g., lower boom pivot, etc.). The boom includes a first actuator (e.g., pneumatic cylinder, electric actuator, hydraulic cylinder, etc.), which has a first end coupled to the turntable and an opposing second end coupled to the lower boom. According to an exemplary embodiment, the first actuator is positioned to raise and lower the lower boom relative to the turntable about the lower boom pivot.

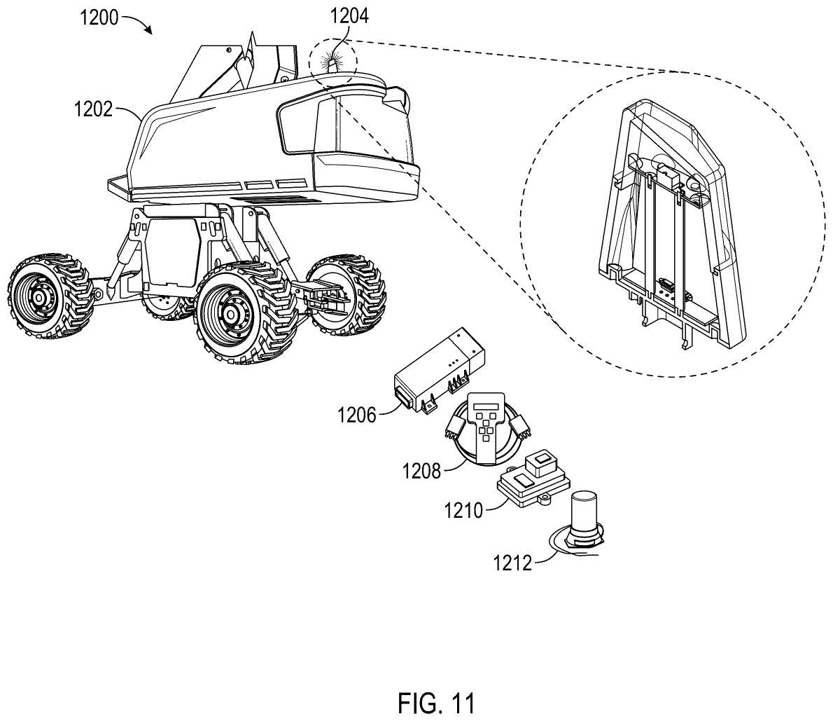

As shown in FIG. 10, the upper boom of telescoping boom lift 1104 has a first end (e.g., intermediate end, etc.), and an opposing second end (e.g., implement end, etc.). According to an exemplary embodiment, the intermediate end of the upper boom is pivotally coupled (e.g., pinned, etc.) to the intermediate end of the lower boom at a joint (e.g., upper boom pivot, etc.). As shown in FIG. 11, the boom of telescoping boom lift 1104 includes an implement (e.g., platform assembly) coupled to the implement end of the upper boom with an extension arm (e.g., jib arm, etc.). In some embodiments, the jib arm is configured to facilitate pivoting the platform assembly about a lateral axis (e.g., pivot the platform assembly up and down, etc.). In some embodiments, the jib arm is configured to facilitate pivoting the platform assembly about a vertical axis (e.g., pivot the platform assembly left and right, etc.). In some embodiments, the jib arm is configured to facilitate extending and retracting the platform assembly relative to the implement end of the upper boom. The boom includes a second actuator (e.g., pneumatic cylinder, electric actuator, hydraulic cylinder, etc.). According to an exemplary embodiment, the second actuator is positioned to actuate (e.g., lift, rotate, elevate, etc.) the upper boom and the platform assembly relative to the lower boom about the upper boom pivot.

According to an exemplary embodiment, the platform assembly is a structure that is particularly configured to support one or more workers. In some embodiments, the platform assembly includes an accessory or tool configured for use by a worker. Such tools may include pneumatic tools (e.g., impact wrench, airbrush, nail gun, ratchet, etc.), plasma cutters, welders, spotlights, etc. In some embodiments, the platform assembly includes a control panel to control operation of the work machines 20 (e.g., the turntable, the boom, etc.) from the platform assembly. In other embodiments, the platform assembly includes or is replaced with an accessory and/or tool (e.g., forklift forks, etc.).

Referring to FIG. 11, a work machine 1202 at a worksite 1200 is provisioned with an indicator 1204 (e.g., a connectivity module with integrated beacon light, control devices, and communications devices). The indicator 1204 may, for example, illuminate a light visible to a user in response to user activation of a “find my machine” or “identify my equipment” application hosted on a user device connected to the local fleet connectivity system 200. The indicator 1204 may function like a conventional work machine warning beacon 1212. The indicator 1204 may also illuminate a light in response to receiving a command that changes access control settings, locks the machine into a certain mode, or to notify an operator of a conditional change of access control settings upon a certain event (e.g., indicator glows yellow to alert the operator that upon powering the machine down, the access controls will change and upon power up, the machine will be accessible only in low speed mode or tow mode, etc.).

In some embodiments, the connectivity module may be configured with a telematics control unit 1206, a multi-function light beacon 1212, one or more multi-channel communication modems 1210, one or more analytics devices 1208, one or more antennas, one or more power sources, one or more positioning systems, one or more local fleet connectivity processors, and one or more interface blocks, one or more machine connectivity provisions, and one or more memory devices. For example, the connectivity module with integrated beacon 1204 may be configured as an integrated connectivity device provisioned with all components required to connect a work machine 1202 that is not provisioned with networking equipment to a local fleet connectivity system 200 or a system for controlling access to work machines. The connectivity module with integrated beacon 1204 may include, for example, a telematics control unit specific componentry included (e.g., multi-color beacon, GPS/GNSS, communications modem, antenna, controller, memory device, interface blocks, housing, etc.) and be affixable to a work machine using temporary or permanent physical, electrical, or electronic connections. The connectivity module connected to the work machine may be configured to selectively enable, activate, disable, and deactivate components of the connectivity module and the work machine to which it is communicatively connected for example, via commands issued from the system for controlling access to work machines. In another example, a connectivity module with integrated beacon 1204 connected to a work machine equipped with headlights may enable and activate the work machine headlights and disable the integral beacon in response to a “find me” command received by the connectivity module from the local fleet connectivity system 200 or in response to a command changing access controls from the system for controlling access to work machines. The connectivity module with integrated beacon 1204 is configured, in some embodiments, to determine what components integral to the module and what components that are machine equipment are activated in response to a command such that only the components necessary to respond to the command are activated and no individual components are activated in conflict with the components activated to respond to the command.

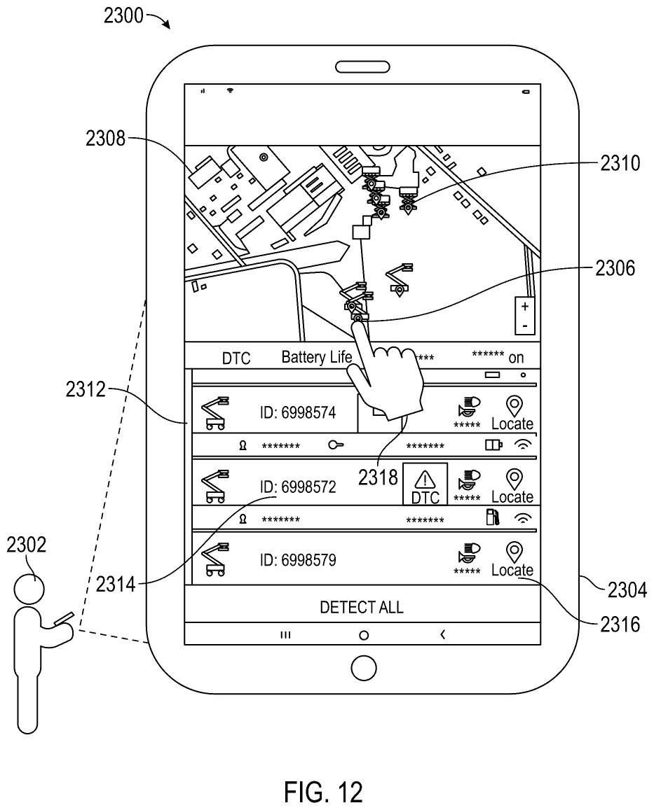

Referring to FIG. 12, a user 2302 may use the system for controlling access to work machines by interacting 2318 with an application hosted on a user device 2304 that generates a user interface 2308. The user device 2304 and various work machines 1202 are interconnected via the local fleet connectivity system 200. The user 2302 selects a machine 2306 from a view of a group of a machines 2310 connected to the local fleet connectivity system 200 at a work site. The user interface 2308 may depict, for example, imagery of a work site with overlays of machine locations (e.g., a map) 2310 and information regarding machine specific information including status (e.g., location, fuel state, state of charge, access controls, users assigned permissions to operate, which features are enables/disabled, etc.) 2312, 2314, 2316. The application may dynamically filter the map to illustrate the total machine population and locations and statuses of individual machines in the population. The application may automatically group machines or machines may be grouped manually. In some examples, a remote user may apply filters (e.g., proximity to a user, rental period expired, rental period less than X number of days/hours remaining, work site location, machine type, machine owner/operator, filters related to machine status including self-test, fuel level, state of charge, etc.) to a specific work site network much the same as can be done locally via an application on a mobile user device (e.g., in the instance where a remote user can apply the desired user configurable rules to assist a local user w/o the need of mobile application use). The user may select a machine or group of machines using an application, edit/revise/control the access parameters/permissions for the machine or group of machines, and communicate with the machine or group of machines (directly or via a cloud) to have that machine provide an access control identify indication (e.g., a colored light, a light pattern, a combination of light colors and patterns, activation of a horn).

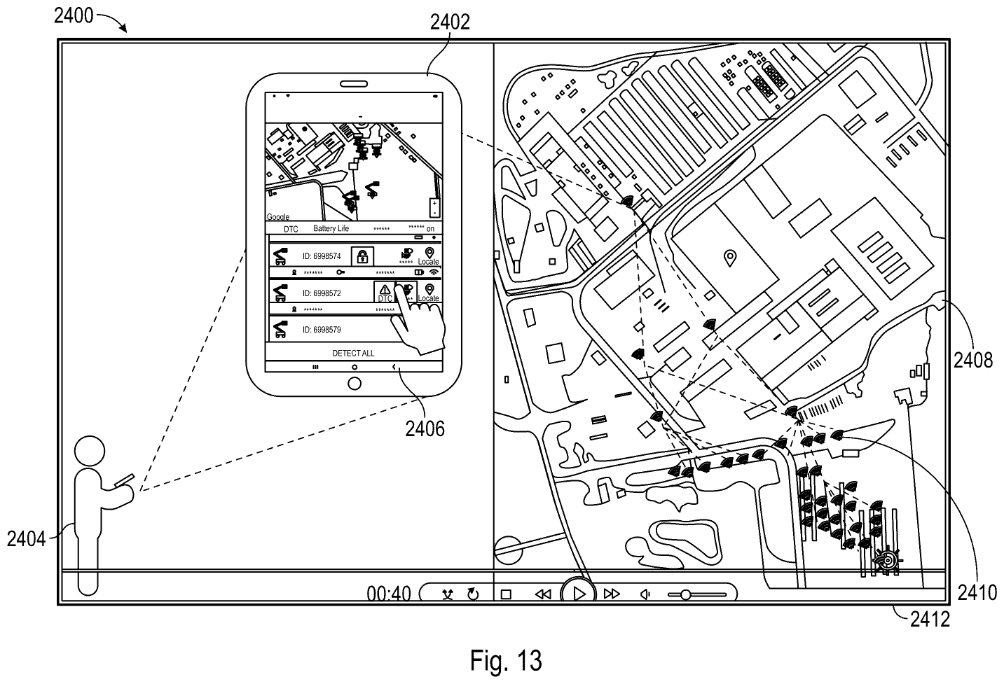

Referring to FIG. 13, a user interface 1800 of a machine connectivity application interoperable with a system for controlling access to work machines is shown, according to an exemplary embodiment. The user interface 2400 may include a map 2408. The map may be an aerial view of a job site. The map 2408 may include machine indicators 2410 that show where machines are disposed on the map 2408. A light on a connectivity module can be used to identify a first machine 2412 of the plurality of machines within the job site and indicate various statuses of the first machine (e.g., fuel level, state of charge, fault status, ignition on/off, in operation, locked in low speed mode, conditionally set to enter tow mode upon power down, etc.). The application user interface 2406 on user device 2402 can be used by a user 2404 to select which status they want to be displayed on a fleet within user defined parameters (e.g., a connected range of the user device). Features of a “find me” or “change access parameters” application can be used independently of or in conjunction with the filter criteria of a desired subset of a fleet. The equipment identification system application can also provide user interfaces for other instructions or commands (e.g., allowing a machine to be powered up or shut down, allowing certain functionalities to be enabled/disabled/limited/etc.). The system and methods for automatic generation of work site equipment groupings is agnostic as to machine type, manufacturer, owner, status, etc. as the system provides for machines, including machines from different manufacturers to be part of the same network through, for example, connectivity modules.

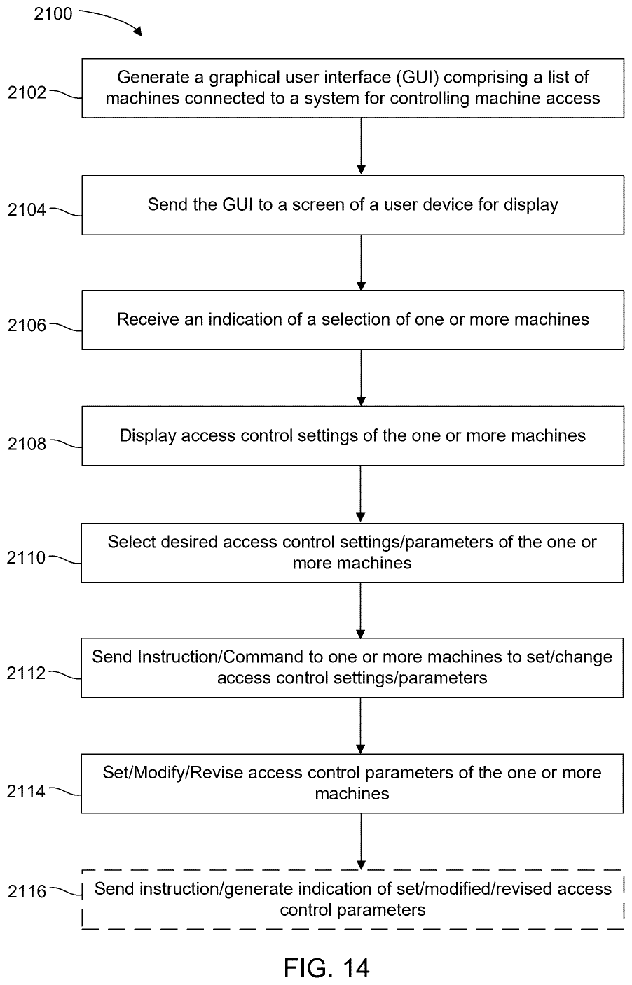

Referring to FIG. 14, a process 2100 (or method) for controlling access to work machines (e.g., on a local fleet connectivity system 200) is shown according to some embodiments. The method may be performed by one or more processing circuits comprising one or more memory devices coupled to one or more processors. The one or more memory devices may be configured to store instructions thereon that, when executed by the one or more processors, cause the one or more processors to perform the operations of the method. In some embodiments, the one or more processing circuits may be integrated into a remote computing system (e.g., cloud and web services 268). In other embodiments, the one or more processing circuits may be integrated into a user device (e.g., user device 272). One or more machines may connect to the user device via a local wireless connectivity system or via a cellular network (e.g., via cell towers 240), or other existing or new means of digital connectivity. Each machine may include a connectivity module for communicating with the system for controlling access to work machines (e.g., connectivity modules 218, 320). The one or more processing circuits may communicate across a wireless network by sending messages to the one or more machines and to one or more user devices each communicatively connected to the network. A user may interact with the machines via an application provided on the user device that displays a graphical user interface (GUI).

Following the activation of a system for controlling access to work machines and deployment of machines to a work site, machines connect to the system and are identified digitally within the system and applications provided through the system. Process 2100 begins at operation 2102 with the generation of a GUI including a list of one or more of the machines connected to the system for controlling access to work machines. In some embodiments, the list may include additional information regarding each machine (e.g., fuel level/SOC, DTC status, ignition on/off, in operation, fault status, ignition on/off, in operation, locked in low speed mode, conditionally set to enter tow mode upon power down, etc.). In some embodiments, the list may include location information regarding each machine (e.g., work site name, latitude and longitude etc.). In some embodiments, the GUI may include a map with the location of each machine, as shown in FIG. 12. At operation 2104, the GUI is sent to a screen of a user device for display. The user device may be, for example, a smartphone, a tablet computer, a laptop computer, a desktop computer, or any device with a screen to display the GUI and that allows the user to interact with the application (e.g., to receive machine data, to send messages, instructions, or commands to the machines, etc.). In other embodiments, the GUI may be sent to a web interface.

At operation 2106, an indication of a selection of a machine or group of machines is received via the GUI. For example, a user may select a machine by clicking the machine name on the list of machines on the GUI with a mouse or touching it on a touchscreen device. In other embodiments, machines may be automatically selected based on their group or a predefined criteria (e.g., machines with expired rental period may be automatically populated to the GUI for access control modification without requiring a user to manually identify them/select them). At operation 2108, in response to receiving the selection of a machine or group of machines from the list, the access control settings/parameters for the machine or group of machines are displayed for the user to view/edit/modify/enable certain functionality/disable certain functionalities, etc. At operation 2110, the user may select and modify access control settings/parameters to the machine. (e.g., lock into tow mode, conditionally set to low speed mode, power off, allow only certain users with credentials to access, etc.). At operation 2112, in response to receiving the selection and/or modification of asset control settings/parameters, an instruction/command is sent to the selected machine or group of machines to change the access control settings/parameters (e.g., disable machine, power off machine, lock in low speed mode, lock in transport mode, conditionally enter and lock in transport mode upon powering down, only allow users with certain credentials to access operate machine at full functionality, etc.). At operation 2114, the access control parameters of the one or more machines are changed. At operation 2116, optionally, an instruction is sent to the selected machine to generate a visual indication or audible indication related to the respective change in access control settings/parameters. It should be understood that instructing the machine to generate an indication may include instructing a connectivity module or visual display coupled to the machine to generate the indication. The user may then identify the selected machine based on the visual or audible indication generated by the indicator to confirm that the correct machine or group of machines has had access control settings set, changed, or modified. The indicator may be, for example, a beacon integrated into the connectivity module that includes a light which is lit when the instruction to generate the indication is received. Additionally or alternatively, the connectivity module can instruct the machine's lights (e.g., headlights, cabin lights, etc.) to act as the visible indicator. The beacon may additionally or alternatively include a speaker to provide the audible indication. Additionally or alternatively, the connectivity module can instruct the machine's horn to act as the audible indicator. The visual and audible indicators can be used in conjunction or independently of one another.

As an example of process 2100, a worksite may have ten machines (e.g., scissor lifts) that are the same model. The scissor lifts may connect to the system for controlling access to work machines. A user device (e.g., a tablet computer) may also connect to the system for controlling access to work machines. A GUI may be generated and displayed on the screen of the tablet computer. The GUI may include a list of the ten scissor lifts and their respective fuel levels, operating conditions, access control settings (e.g., which operators may access the machines, what functionalities of the machines are enabled, whether the machines are locked in a certain mode, etc.). If, for example, one of the scissor lifts has a fuel level that is very low, (or is a rental machine that has been in use past its rental period, or is at an unauthorized location,) the user may select that scissor lift to modify its access control settings/parameters. Alternatively, the system may automatically select that scissor lift based on such criteria or similar preset settings that indicate a need to change access control settings/parameters. After the selection is received, the user may send an instruction/command to the selected scissor lift to enter and lock into reduced speed mode. Additionally, an instruction may be sent to the selected scissor lift to activate the beacon light of the connectivity module coupled to the selected scissor lift and generate a visual indication that the scissor lift has been locked in low speed mode. The user may then locate the selected scissor lift based on the visual indication and, for example, refuel the selected scissor lift.

The user may apply one or more dynamic filters (e.g., machine feature or status criteria) to a map of machines at a work site through the application to illustrate one or more machine population. In some implementations, the user may apply such a filter to a specific jobsite network much the same as can be done locally via a mobile application. The process 2100 may also include using a visual or audible indication on the machine to illustrate various statuses of the machine (fuel level/SOC, battery level, DTC status, ignition on/off, in operation, etc.). For example an indication of a selection of a status or condition may be received via the GUI on the user device, and a message may be sent in response to the selection instructing the selected machines to indicate the selected status or condition using one or both of the visual or audible indication. The process 2100 may further include using the application as an interface for a user to select which status they want to be displayed on a fleet of machines within a connected range of the user's device or within a designated proximity to a user. The method may also include a user sending commands to a machine through the application (e.g. commanding an identified machine to be powered up or shut down, disabling or enabling an identified machine, etc.). For example, an indication of a selection of an option to power up or power down a machine may be received via the GUI on the user device, and a message may be sent in response to the indication instructing the selected machine to power up or power down. As another example, an indication of a selection of an option to enable or disable a machine may be received via the GUI on the user device, and a message may be sent in response to the indication instructing the selected machine to enable or disable operation of the machine.

Although the systems and methods are described herein with reference to a lift device, a lift assembly, or a work machine, the systems and methods may additionally or alternatively be applied to any other type of vehicle or machine. By way of example, these systems and methods may apply to any type of lift device (e.g., boom lifts, scissor lifts, vertical lifts, manual lifts, aerial work platforms, telehandlers, etc.). By way of another example, these systems and methods may apply to vocational vehicles, such as fire fighting vehicles, fire trucks, concrete mixers, delivery vehicles, military vehicles, refuse vehicles, etc.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

While various circuits with particular functionality are shown in FIGS. 1-3, it should be understood that the controller 44 may include any number of circuits for completing the functions described herein. For example, the activities and functionalities of the control system 60 may be combined in multiple circuits or as a single circuit. Additional circuits with additional functionality may also be included. Further, the controller 44 may further control other activity beyond the scope of the present disclosure.

As mentioned above and in one configuration, the “circuits” of the control system 60 may be implemented in machine-readable medium for execution by various types of processors, such as the processor 52 of FIG. 1. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Although this description may discuss a specific order of method steps, the order of the steps may differ from what is outlined. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the load map interface systems and methods as shown in the various exemplary embodiments is illustrative only. Additionally, any element disclosed in one embodiment may be incorporated or utilized with any other embodiment disclosed herein. For example, the warning zones of the exemplary embodiment may be eliminated or additional zones may be added. Although only one example of an element from one embodiment that can be incorporated or utilized in another embodiment has been described above, it should be appreciated that other elements of the various embodiments may be incorporated or utilized with any of the other embodiments disclosed herein.

Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A system for controlling access to a work machine, the system comprising:
a connectivity module, the connectivity module communicatively and physically coupled to the work machine;
one or more processing circuits configured to affect at least one functionality of the work machine, the one or more processing circuits comprising one or more memory devices coupled to one or more processors, the one or more memory devices configured to store instructions thereon that, when executed by the one or more processors, cause the one or more processors to:
designate at least one selected work machine;
receive data indicative of one or more access control settings of the selected work machine;
send a signal configured to cause a modification to the one or more access control settings of the selected work machine; and
cause the modification to the one or more access control settings of the selected work machine.

2. The system of claim 1, further comprising:
a user device comprising a GUI and including at least one of a laptop, a cellular device, a tablet, a computer, or a remote computer system, the user device configured to:
receive, via the GUI, a designation of the at least one selected work machine; and
send the designation of the at least one selected work machine to the connectivity module or the one or more processing circuits via a network connection.

3. The system of claim 1, wherein the data indicative of the one or more access control settings of the selected work machine comprises at least one of: a status of the selected work machine, a state of the selected work machine, a functionality of the selected work machine, a membership of the selected work machine in a group, an identity of a user who may check in or check out the selected work machine, a credential requirement to access the selected work machine, a time period of permitted use, or a geographic location of permitted use.

4. The system of claim 1, wherein the modification to the one or more access control settings is setting a state of the selected work machine to a tow mode or a low-speed mode upon a next start-up of the selected work machine.

5. The system for controlling access to one or more work machines of claim 1, wherein the connectivity module is configured to indicate a status or condition of the at least one selected work machine.

6. The system of claim 1, wherein:
the modification to the one or more access control settings of the selected work machine disables at least one functionality or system of the selected work machine; and
wherein the one or more memory devices are configured to store instructions thereon that, when executed by the one or more processors, further cause the one or more processors to:
receive a signal configured to re-enable the disabled at least one functionality or system of the selected work machine upon satisfaction of a condition.

7. The system of claim 1, wherein:
the one or more memory devices are configured to store instructions thereon that, when executed by the one or more processors, further cause the one or more processors to:
indicate the modification to the one or more access control settings by causing at least one of an audible signal or a visual signal;
the at least one selected work machine is one of a plurality of work machines;
the connectivity module is one of a plurality of connectivity modules, each connectivity module of the plurality of connectivity modules comprising:
a self-contained unit physically coupled to one work machine of the plurality of work machines, and
comprises a beacon, the beacon comprising one or both of a light or sound generator, wherein the beacon is configured to identify the one work machine to which it is physically coupled by generating one or both of the audible signal or the visual signal.

8. A system for controlling access to a work machine, the system comprising:
one or more processing circuits comprising one or more memory devices coupled to one or more processors, the one or more memory devices configured to store instructions thereon that, when executed by the one or more processors, cause the one or more processors to:
generate a GUI comprising a list including the work machine;
receive, via a network, a signal indicative of a selected work machine and a connectivity module coupled thereto;
receive at least one access control setting associated with the selected work machine;
receive, via the GUI, an indication to set or change the at least one access control setting associated with the selected work machine;
send a signal to the connectivity module, the signal configured to set or change the at least one access control setting of the selected work machine; and
cause the at least one access control setting of the selected work machine to be set or changed.

9. The system of claim 8, further comprising:
a user device communicatively connected to the network, the user device comprising a screen and including at least one of a laptop, a cellular device, a tablet, a computer, or a remote computer system;
wherein the one or more memory devices are configured to store instructions thereon that, when executed by the one or more processors, further cause the one or more processors to:
cause the GUI to display on the screen of the user device, and
receive, from the user device and in response to an indication of a selection of one or more machines from the list, the signal indicative of the selected work machine and the connectivity module coupled thereto.

10. The system of claim 8, wherein the at least one access control setting associated with the selected work machine comprises at least one of: a status of the selected work machine, a state of the selected work machine, a functionality of the selected work machine, a membership of the selected work machine in a group, an identity of a user who may check in or check out the selected work machine, a credential requirement to access the selected work machine, a time period of permitted use, or a geographic location of permitted use.

11. The system of claim 8, wherein the indication to set or change the at least one access control setting associated with the selected work machine is received automatically upon the work machine meeting a criteria or preset setting.

12. The system of claim 8, wherein the indication to set or change the at least one access control setting associated with the selected work machine comprises a command to limit or disable at least one functionality of the selected work machine; and
the connectivity module coupled thereto is configured to indicate that the at least one functionality is limited or disabled by activating a beacon.

13. The system of claim 8, wherein the one or more memory devices are configured to store instructions thereon that, when executed by the one or more processors, further cause the one or more processors to:
cause an onboard display of the selected work machine to provide an indication of a change in status of the selected work machine.

14. The system for controlling access to one or more work machines of claim 8, wherein the connectivity module is one of a plurality of connectivity modules, each connectivity module of the plurality of connectivity modules comprising a beacon, the beacon comprising one or both of a light or sound generator, wherein the beacon is configured to identify the work machine to which it is physically coupled by generating one or both of an audible signal or a visual signal.

15. A method for controlling access to a work machine, the method comprising:
generating, by one or more processing circuits, a GUI comprising a list including the work machine;
receiving, by the one or more processing circuits, via a wireless network, a signal indicative of a selected work machine and a connectivity module coupled thereto;
receiving, by the one or more processing circuits, at least one access control setting associated with the selected work machine;
receiving, by the one or more processing circuits, via the GUI, an indication to set or change the at least one access control setting associated with the selected work machine;
sending, by the one or more processing circuits, a signal to the connectivity module, the signal configured to set or change the at least one access control setting of the selected work machine; and
causing, by the one or more processing circuits, the at least one access control setting of the selected work machine to be set or changed.

16. The method of claim 15, further comprising:
causing, by the one or more processing circuits, the GUI to display on a screen of a user device; and
receiving, by the one or more processing circuits, an indication of a selection of one or more machines from the list.

17. The method of claim 15, wherein the at least one access control setting associated with the selected work machine comprises at least one of: a status of the selected work machine, a state of the selected work machine, a functionality of the selected work machine, a membership of the selected work machine in a group, an identity of a user who may check in or check out the selected work machine, a credential requirement to access the selected work machine, a time period of permitted use, or a geographic location of permitted use.

18. The method of claim 15, further comprising:
indicating, by the one or more processing circuits, a modification to the at least one access control setting by causing at least one of an audible signal or a visual signal to occur on the selected work machine.

19. The method of claim 15, further comprising:
receiving, by the one or more processing circuits, a signal configured to re-enable a disabled functionality or a disabled system of the selected work machine upon a satisfaction of a condition.

20. The method of claim 15, further comprising:
causing, by the one or more processing circuits, an onboard display of the selected work machine to provide an indication of a change in status of the selected work machine.
